(19) United States
(12) Patent Application Publication
(10) Pub. No.: US 2025/0007099 A1
(43) Pub. Date: Jan. 2, 2025

(54) POWER STORAGE CELL AND METHOD OF PRODUCING ELECTRODE ASSEMBLY

(71) Applicant: TOYOTA JIDOSHA KABUSHIKI KAISHA, Toyota-shi (JP)

(72) Inventors: Yusuke IKEDA, Miyoshi-shi (JP); Kazuhito Kato, Toyota-shi (JP); Takaaki Goto, Seto-shi (JP); Masayoshi Haga, Nagoya-shi (JP); Minehiro Funato, Toyota-shi (JP); Tsuyoshi Kaneko, Nisshin-shi (JP); Yuka Yokoi, Nagoya-shi (JP)

(73) Assignee: TOYOTA JIDOSHA KABUSHIKI KAISHA, Toyota-shi (JP)

(21) Appl. No.: 18/678,659

(22) Filed: May 30, 2024

(30) Foreign Application Priority Data
Jun. 30, 2023 (JP) 2023-108007

(51) Int. Cl. H01M 50/46; H01M 10/04; H01M 50/466

(52) U.S. Cl. CPC H01M 50/46; H01M 10/0459; H01M 50/466

(57) ABSTRACT

A power storage cell includes: an electrode assembly. The electrode assembly includes a plurality of positive electrodes and a plurality of negative electrodes disposed side by side in a thickness direction, and a separator. The electrode assembly has a shape longer in a width direction. The electrode assembly includes an upper portion, a bottom portion, a first end portion, and a second end portion. A first welding portion is formed in the first end portion. A second welding portion is formed in the second end portion. A third welding portion in contact with the first welding portion and a fourth welding portion in contact with the second welding portion are formed in the bottom portion. The third welding portion and the fourth welding portion are disposed at an interval with a central portion of the bottom portion being interposed between the third welding portion and the fourth welding portion.

### CROSS REFERENCE TO RELATED APPLICATIONS

This nonprovisional application is based on Japanese Patent Application No. 2023-108007 filed on Jun. 30, 2023 with the Japan Patent Office, the entire contents of which are hereby incorporated by reference.

### BACKGROUND

### Field

The present disclosure relates to a power storage cell and a method of producing an electrode assembly.

### Description of the Background Art

Japanese Patent Application Laid-Open No. 2009-88279 discloses a method of bonding an electrode and a separator or separator to each other using an adhesive containing a component of the same kind as the binder of the electrode as a main component in an electrode assembly in which an electrode containing a binder is laminated via a separator.

### SUMMARY

The electrode assembly is repeatedly expanded and contracted by repeating charging and discharging. On this occasion, the electrolyte solution enters the electrode assembly and exits therefrom via the periphery of the electrode assembly. In the electrode assembly formed to have a laterally long shape, the permeation state of the electrolyte solution is maintained in the peripheral portion of the electrode assembly due to the entering and exiting of the electrolyte solution via the periphery of the electrode assembly. On the other hand, with passage of time, the electrolyte solution is likely to be exhausted in inside of the electrode assembly, in particular, in the central portion of the electrode assembly. As a result, permeation of the electrolyte solution may become uneven inside the electrode assembly.

It is an object of the present disclosure to provide a power storage cell in which permeation of an electrolyte solution in an electrode assembly is less likely to become uneven.

[1] A power storage cell comprising:
an electrode assembly;
a cell case that accommodates the electrode assembly; and
an electrolyte solution accommodated in the cell case, wherein
the electrode assembly includes a plurality of positive electrodes and a plurality of negative electrodes disposed side by side in a thickness direction, and a separator that insulates each positive electrode and each negative electrode,
the electrode assembly has a shape longer in a width direction than in the thickness direction, the width direction being orthogonal to both the thickness direction and an upward/downward direction,
the electrode assembly includes an upper portion, a bottom portion, a first end portion located at one end in the width direction, and a second end portion located at the other end in the width direction,
each of the plurality of positive electrodes includes a positive electrode tab protruding from the first end portion,
each of the plurality of negative electrodes includes a negative electrode tab protruding from the second end portion,
a first welding portion is formed in the first end portion at a portion located below the positive electrode tab,
a second welding portion is formed in the second end portion at a portion located below the negative electrode tab,
a third welding portion in contact with the first welding portion and a fourth welding portion in contact with the second welding portion are formed in the bottom portion,
the third welding portion and the fourth welding portion are disposed at an interval with a central portion of the bottom portion being interposed between the third welding portion and the fourth welding portion.

The electrode assembly is expanded and contracted when charging/discharging is performed. With the expansion and contraction of the electrode assembly, the electrolyte solution enters the electrode assembly and exits therefrom. On the other hand, in each of the welding portions, micropores of the separator are closed and therefore the electrolyte solution cannot pass therethrough. Therefore, by forming the welding portions at the lower portions of the electrode assembly at the both ends in the width direction and the both ends of the bottom portion of the electrode assembly in the width direction, the entering and exiting of the electrolyte solution at the welding portions are blocked, with the result that it is possible to maintain a state in which the electrolyte solution is permeated in the corner portions of the bottom portion of the electrode assembly. Therefore, the permeation of the electrolyte solution inside the electrode assembly is less likely to become uneven.

FIG. 1 is a schematic view showing a degree of permeation of an electrolyte solution in an electrode assembly in which no welding portion is formed. In FIG. 1, the leftward/rightward direction represents the lateral direction of the electrode assembly, and the upward/rightward direction represents the upward/rightward direction of the electrode assembly. It is considered that the electrolyte solution having been permeated in the corner portions of the bottom portion of the electrode assembly as described above is permeated with passage of time into a region Z, which is located at the central portion of FIG. 1 and in which the electrolyte solution is less likely to be permeated, with the result that variation in the degree of permeation of the electrolyte solution is suppressed.

[2] The power storage cell according to [1], wherein each of a height of the first welding portion and a height of the second welding portion is equal to or more than ⅓ and equal to or less than ½ of a height of the electrode assembly.

[3] The power storage cell according to [1] or [2], wherein each of a length of the third welding portion in the width direction and a length of the fourth welding portion in the width direction is equal to or more than ¼ and equal to or less than ⅓ of a length of the electrode assembly in the width direction.

[4] A method of producing an electrode assembly in which a positive electrode and a negative electrode are disposed side by side with a separator being interposed between the positive electrode and the negative electrode, the method comprising:
preparing the separator;
disposing the positive electrode on the separator;
forming a folded-back portion for positioning the positive electrode with respect to the separator by folding back the separator, and disposing the separator on the positive electrode;
welding the separator to the positive electrode by heating the separator;
disposing the negative electrode on the separator welded on the positive electrode;
forming a folded-back portion for positioning the negative electrode with respect to the separator by folding back the separator, and disposing the separator on the negative electrode; and
welding the separator to the negative electrode by heating the separator.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view showing a degree of permeation of an electrolyte solution in an electrode assembly in which a welding portion is not formed.

FIG. 2 is a perspective view schematically showing a power storage cell according to the first embodiment.

FIG. 3 is a cross-sectional view of the power storage cell shown in FIG. 2.

FIGS. 4A and 4B are perspective views schematically showing an electrode assembly according to the first embodiment.

FIG. 5 schematically shows an electrode assembly according to a second embodiment.

FIG. 6 schematically shows a method of producing an electrode assembly according to a second embodiment.

FIG. 7 schematically shows a method of producing an electrode assembly according to a second embodiment.

FIG. 8 is a diagram schematically showing a method of producing an electrode assembly according to a second embodiment.

FIG. 9 schematically shows a method of producing an electrode assembly according to a second embodiment.

FIG. 10 schematically shows an electrode assembly according to a third embodiment.

FIG. 11 schematically shows a method of producing an electrode assembly according to a third embodiment.

FIG. 12 schematically shows a method of producing an electrode assembly according to a third embodiment.

FIG. 13 schematically shows a method of producing an electrode assembly according to a third embodiment.

FIG. 14 schematically shows a method of producing an electrode assembly according to a third embodiment.

FIG. 15 schematically shows a method of producing an electrode assembly according to a third embodiment.

FIG. 16 schematically shows a method of producing an electrode assembly according to a third embodiment.

FIG. 17 schematically shows an electrode assembly according to a fourth embodiment.

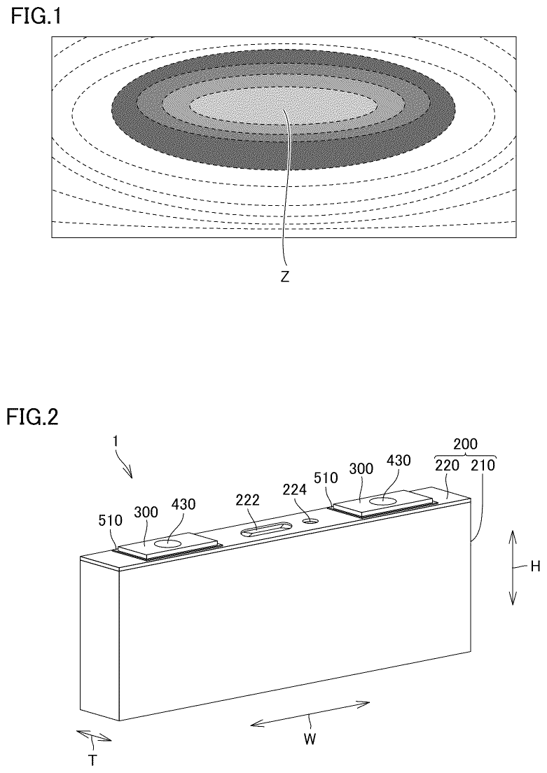

### DESCRIPTION OF THE PREFERRED EMBODIMENTS

### Embodiment 1

A power storage cell according to the present embodiment will be described with reference to the drawings. In the drawings referred to below, the same or corresponding members are denoted by the same reference numerals.

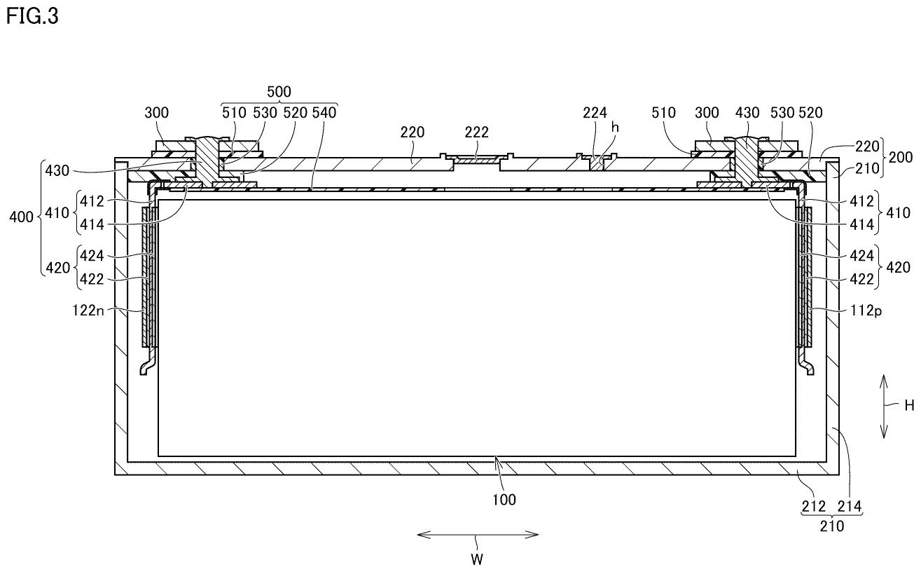

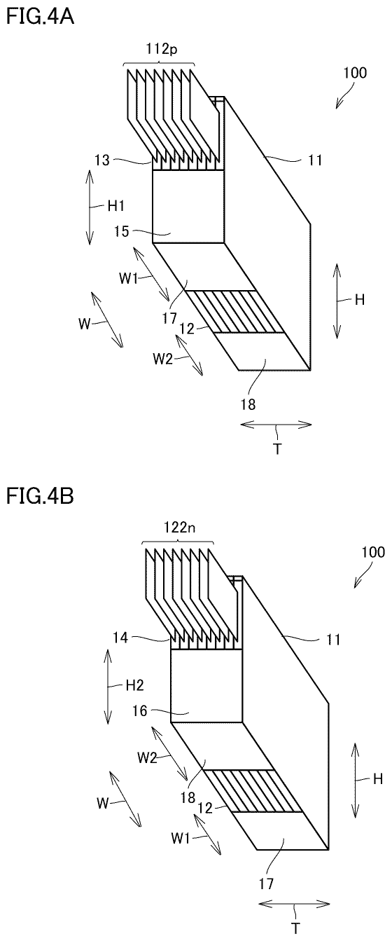

FIG. 2 is an example of a perspective view schematically showing a power storage cell according to the present embodiment. FIG. 3 is a cross-sectional view of the power storage cell shown in FIG. 2. FIGS. 4A and 4B are perspective views schematically showing an electrode assembly according to the present embodiment.

As shown in FIGS. 2 and 3, the power storage cell 1 includes an electrode assembly 100, a cell case 200, a pair of external terminals 300, a pair of coupling members 400, an insulating member 500, and an electrolyte solution (not shown).

The electrode assembly 100 includes a plurality of positive electrodes 110 and a plurality of negative electrodes 120 arranged in the thickness direction (T in FIG. 2) and a separator 130 for insulating the positive electrodes 110 and the negative electrodes 120. The electrode assembly 100 is formed in a rectangular shape longer than the thickness direction in a direction (W in FIG. 2) orthogonal to both the thickness direction and the vertical direction (H in FIG. 2). The electrode assembly 100 includes an upper portion 11, a bottom portion 12, a first end portion 13 positioned at one end in the width direction, and a second end portion 14 positioned at the other end in the width direction.

Each positive electrode 110 is formed in a rectangular shape elongated in the width direction. Each positive electrode 110 includes a positive electrode current collector foil and positive electrode active material layers provided on both surfaces of the positive electrode current collector foil. The positive electrode 110, specifically the positive electrode current collector foil, includes a positive electrode tab 112p protruding from the first end portion 13 toward one side in the width direction. The positive electrode tab 112p is not provided with a positive electrode active material layer.

Each negative electrode 120 is formed in a rectangular shape elongated in the width direction. Each negative electrode 120 includes a negative electrode current collector foil and a negative electrode active material layer provided on both surfaces of the negative electrode current collector foil. The negative electrode 120, specifically the negative electrode current collector foil, includes a negative electrode tab 122n protruding from the second end portion 14 toward one side in the width direction. The negative electrode tab 122n is not provided with the negative electrode active material layer.

A first welding portion 15 is formed in a portion of the first end portion 13 located below the positive electrode tab 112p. A second welding portion 16 is formed in a portion of the second end portion 14 located below the negative electrode tab 122n. In the bottom portion 12, a third welding portion 17 in contact with the first welding portion 15 and a fourth welding portion 18 in contact with the second welding portion 16 are formed. With such a configuration, the entrance and exit of the electrolyte solution at the first welding portion 15, the second welding portion 16, the third welding portion 17, and the fourth welding portion 18 can be blocked. As a result, the state in which the electrolyte solution is permeated into the corner portion (The first welding portion 15 and the third welding portion 17 are in contact with each other, and the second welding portion 16 and the fourth welding portion 18 are in contact with each other.) of the bottom portion 12 can be maintained. Therefore, permeation of the electrolyte solution in the inside of the electrode assembly 100 is less likely to become uneven.

The first welding portion 15, the second welding portion 16, the third welding portion 17, and the fourth welding portion 18 may be formed of, for example, a resin. The first welding portion 15, the second welding portion 16, the third welding portion 17, and the fourth welding portion 18 may be formed of the same resin, or may be formed of different resins.

The height H1 of the first welding portion 15 and the height H2 of the second welding portion 16 are preferably equal to or more than ⅓ and equal to or less than ½ of the height of the electrode assembly 100. With such a height, it is expected that the permeation of the electrolyte solution becomes more uniform.

The third welding portion 17 and the fourth welding portion 18 are disposed at an interval with the central portion of the bottom portion 12 interposed therebetween. This is because if a welding portion is formed over the entire bottom portion 12, the electrolyte solution cannot enter and exit from the bottom portion 12.

The width-direction length W1 of the third welding portion 17 and the width-direction length W2 of the fourth welding portion 18 are preferably equal to or more than ¼ and equal to or less than ⅓ of the width-direction length of the electrode assembly 100. With such a length, it is expected that the permeation of the electrolyte solution becomes more uniform.

The separator 130 insulates the positive electrode 110 from the negative electrode 120. The separator 130 is made of an insulating material, and has minute voids that allow penetration of ions.

The cell case 200 houses the electrode assembly 100. The cell case 200 contains an electrolyte solution (not shown). The cell case 200 is sealed. The cell case 200 includes a case main body 210 and a lid 220.

The case main body 210 has an opening that opens upward. The case main body 210 is made of metal such as aluminum. As shown in FIG. 3, the case main body 210 includes a bottom wall 212 and a peripheral wall 214. The bottom wall 212 is formed in a rectangular and flat plate shape. The peripheral wall 214 rises from the bottom wall 212. The peripheral wall 214 is formed in a quadrangular cylindrical shape. The length of the peripheral wall 214 in the width direction is longer than the length of the peripheral wall 214 in the thickness direction. The length of the peripheral wall 214 in the height direction is longer than the length of the peripheral wall 214 in the thickness direction.

The lid 220 closes the opening of the case main body 210. The lid 220 is connected to the opening by welding or the like. The lid 220 is formed in a flat plate shape. The lid 220 is made of metal such as aluminum. The lid 220 includes a pressure release valve 222 and a sealing member 224.

The pressure release valve 222 is formed at the center of the lid 220. The pressure release valve 222 is formed so as to break when the internal pressure of the cell case 200 becomes equal to or higher than a predetermined pressure. When the pressure release valve 222 breaks, the gas in the cell case 200 is released to the outside of the cell case 200 through the pressure release valve 222, so that the internal pressure of the cell case 200 decreases.

The sealing member 224 seals the liquid injection port h formed in the lid 220. The liquid injection port h is a through hole for injecting the electrolyte solution into the cell case 200 in the production process of the power storage cell 1. After the electrolyte solution is injected into the case main body 210 through the liquid injection port h, the liquid injection port h is sealed by the sealing member 224.

The pair of external terminals 300 is fixed on the cell case 200. One of the pair of external terminals 300 is a positive electrode external terminal and the other is a negative electrode external terminal. Each external terminal 300 is fixed to the upper surface of the lid 220 via an upper insulating portion 510 described later. Each external terminal 300 is made of a metal such as aluminum. Each external terminal 300 is formed, for example, in a rectangular parallelepiped shape. A bus bar (not shown) is connected to each external terminal 300 by welding or the like.

The pair of coupling members 400 connects the plurality of electrode tabs 112p and 122n to the external terminal 300. One of the coupling members 400 connects the plurality of positive electrode tabs 112p and the positive electrode external terminal 300, and the other coupling member 400 connects the plurality of negative electrode tabs 122n and the negative electrode external terminal 300. Since each of the pair of coupling members 400 has substantially the same structure, one of the coupling members 400 will be described below.

The coupling member 400 includes a current collecting tab 410, a sub-tab 420, and a coupling pin 430.

The current collecting tab 410 has a lateral portion 412 and an upper portion 414. The lateral portion 412 is positioned on the lateral side of the electrode assembly 100 in the width direction. The upper portion 414 is positioned above the electrode assembly 100. The upper portion 414 extends inward in the width direction from the upper end of the lateral portion 412.

The sub-tab 420 connects the plurality of positive electrode tabs 112p to the current collecting tab 410. One end portion 422 of the sub-tab 420 is connected to the plurality of positive electrode tabs 112p by welding or the like, and the other end portion 424 of the sub-tab 420 is connected to the lateral portion 412 of the current collecting tab 410 by welding or the like.

The coupling pin 430 connects the current collecting tab 410 and the external terminal 300. The coupling pin 430 connects the upper portion 414 and the external terminal 300. Specifically, the lower end portion of the coupling pin 430 is connected to the upper portion 414 by welding or the like in a state of being inserted into a through hole provided in the upper portion 414, and the upper end portion of the coupling pin 430 is connected to the external terminal 300 by welding, caulking or the like in a state of being inserted into a through hole provided in the external terminal 300.

The insulating member 500 insulates the cell case 200 from the coupling member 400. The insulating member 500 includes an upper insulating portion 510, a lower insulating portion 520, an insulator 530, and an insulating plate 540.

The upper insulating portion 510 is fixed to the upper surface of the lid 220. The upper insulating portion 510 is disposed between the lid 220 and the external terminal 300. The upper insulating portion 510 is provided with an insertion hole through which the coupling pin 430 is inserted.

The lower insulating portion 520 is fixed to the lower surface of the lid 220. The lower insulating portion 520 is disposed between the lid 220 and the lower portion of the upper portion 414 and the coupling pin 430. The lower insulating portion 520 is provided with an insertion hole through which the coupling pin 430 is inserted.

The insulator 530 is disposed between the coupling pin 430 and the lid 220. The insulator 530 is formed in a cylindrical shape and surrounds the coupling pin 430.

The insulating plate 540 is fixed to the lower surface of the upper portion 414. The insulating plate 540 is disposed above the electrode assembly 100. A through hole is formed in a portion of the insulating plate 540 located below the pressure release valve 222 and a portion of the insulating plate 540 located below the liquid injection port h.

As described above, in the power storage cell 1 of the present embodiment, the first welding portion 15 and the second welding portion 16 are formed below the first end portion 13 and the second end portion 14 positioned at both ends in the width direction of the electrode assembly 100. A third welding portion 17 and a fourth welding portion 18 are formed at both ends of the bottom portion 12 of the electrode assembly 100. With such a configuration, it is possible to block in/out of the electrolyte solution in/from the first welding portion 15, the second welding portion 16, the third welding portion 17, and the fourth welding portion 18, and it becomes difficult for the electrolyte solution to impregnate uniformly inside the electrode assembly 100.

### Embodiment 2

In this embodiment, an electrode assembly and a method of producing the electrode assembly which can be used in Embodiment 1 will be described with reference to the drawings. The description of the same contents as those of the first embodiment will be omitted.

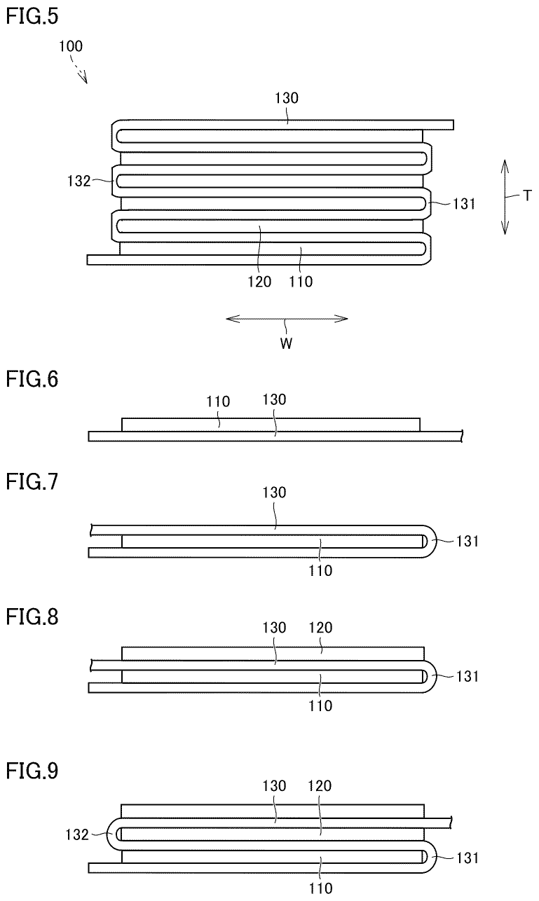

FIG. 5 is a diagram schematically showing an electrode assembly according to the present embodiment. The electrode assembly 100 according to the present embodiment includes a plurality of positive electrodes 110 and a plurality of negative electrodes 120 arranged side by side in the thickness direction, a separator 130 formed in a folded shape to insulate the positive electrodes 110 and the negative electrodes 120 from each other, and has a shape elongated in the width direction orthogonal to both the thickness direction and the vertical direction than the thickness direction, and includes an upper portion 11, a bottom portion 12, a first end portion 13 positioned at one end in the width direction, and a second end portion 14 positioned at the other end in the width direction, the plurality of positive electrode 110 includes a positive electrode tab 112p protruding from the first end portion 13, and the plurality of negative electrode 120 includes a negative electrode tab 122n protruding from the second end portion 14. The separator 130 includes a first folded-back portion 131 and a second folded-back portion 132. The first folded-back portion 131 is formed in the first end portion 13. The second folded-back portion 132 is formed in the second end portion 14. The first folded-back portion 131 is welded to the positive electrode 110. The second folded-back portion 132 is welded to the negative electrode 120.

The separator 130 of the electrode assembly 100 in this embodiment is folded between the positive electrode 110 and the negative electrode 120, and is welded to the end portion of the positive electrode 110 and the end portion of the negative electrode 120. In this way, positional displacement of the positive electrode 110 and the negative electrode 120 with respect to the separator 130 can be suppressed.

Next, a production process of the electrode assembly 100 will be described. The method of producing the electrode assembly 100 according to the present embodiment is a method of producing the electrode assembly 100 in which the positive electrode 110 and the negative electrode 120 are disposed side by side with the separator 130 interposed therebetween, the method including: a step of preparing the separator 130 (preparation step), a step of disposing the positive electrode 110 on the separator 130 (positive electrode disposing step), and forming a first folded-back portion 131 for positioning the positive electrode 110 with respect to the separator 130 by folding back the separator 130, and disposing the separator 130 on the positive electrode 110 (first folding step), a step of disposing the negative electrode 120 on the separator 130 disposed on the positive electrode 110 (negative electrode disposing step), a step of forming the second folded-back portion 132 for positioning the negative electrode 120 with respect to the separator 130 by folding back the separator 130, and a step of disposing the separator 130 on the negative electrode 120 (second folding step), and a step of heating the first folded-back portion 131 and the second folded-back portion 132 to be welded to the positive electrode 110 and the negative electrode 120 (welding step).

In the preparation step, the long separator 130 is prepared.

In the positive electrode disposing step, the positive electrode 110 is arranged on the separator 130. FIG. 6 shows the state after the positive electrode disposing step.

In the first folding step, the separator 130 is folded back so that the separator 130 is disposed on the positive electrode 110. Thereby, the first folded-back portion 131 is formed in the separator 130. The first folded-back portion 131 positions the positive electrode 110 with respect to the separator 130. That is, in this step, the first folded-back portion 131 for positioning the positive electrode 110 with respect to the separator 130 is formed by folding back the separator 130, and the separator 130 is disposed on the positive electrode 110. FIG. 7 shows the state after the first folding step.

In the negative electrode disposing step, the negative electrode 120 is disposed on the separator 130 disposed on the positive electrode 110. FIG. 8 shows the state after the negative electrode disposing step.

In the second folding step, similarly to the first folding step, the separator 130 is folded back to form the second folded-back portion 132 for positioning the negative electrode 120 with respect to the separator 130, and the separator 130 is disposed on the negative electrode 120. FIG. 9 shows the state after the second folding step.

Then, the positive electrode disposing step, the first folding step, the negative electrode disposing step, and the second folding step are repeated in this order.

In the welding step, the first folded-back portion 131 and the second folded-back portion 132 are heated to be welded to the positive electrode 110 and the negative electrode 120. The heating method is not particularly limited, and examples thereof include a heater.

In the welding step, it is preferable that at least one selected from the group consisting of the upper portion 11 and the bottom portion 12 is heated to weld the separator 130 to the positive electrode 110 and the negative electrode 120. The electrode assembly 100 is mounted on a car, for example. When the vehicle is mounted, vibration is often applied in the vertical direction. Accordingly, in the electrode assembly 100, by heating at least one selected from the group consisting of the upper portion 11 and the bottom portion 12 in the vertical direction, positional displacement of the positive electrode 110 and the negative electrode 120 with respect to the separator 130 is further suppressed. In the welding step, the upper portion 11 and the bottom portion 12 are preferably heated to be welded to the positive electrode 110 and the negative electrode 120.

The upper portion 11 and the bottom portion 12 may be heated entirely or only partially. The upper portion 11 and the bottom portion 12 are preferably heated entirely.

As described above, in the electrode assembly 100 and the method of producing the same according to the present embodiment, the positive electrode 110 and the negative electrode 120 are positioned with respect to the separator 130 by heating and welding the first folded-back portion 131 and the second folded-back portion 132 of the separator 130, so that positional displacement of the positive electrode 110 and the negative electrode 120 with respect to the separator 130 is suppressed.

### Embodiment 3

In this embodiment, an electrode assembly and a method of producing the electrode assembly which can be used in Embodiment 1 will be described with reference to the drawings. The description of the same contents as those of the first and second embodiments will be omitted.

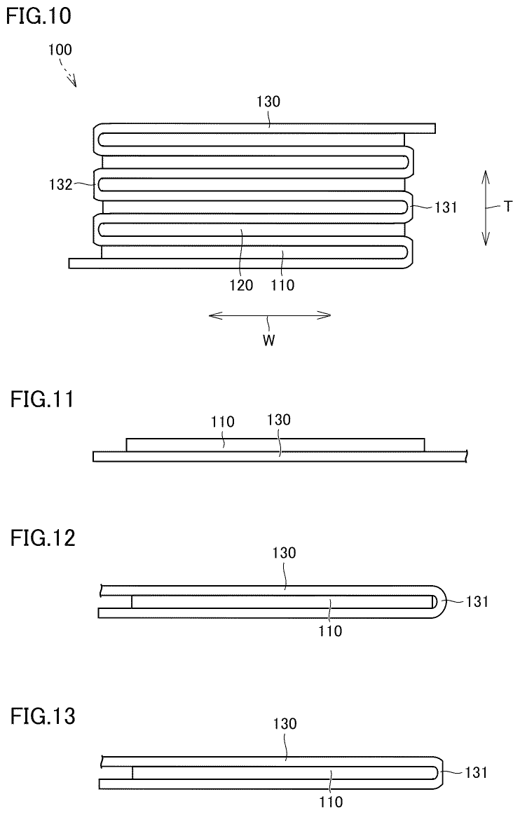

FIG. 10 is a diagram schematically showing an electrode assembly according to the present embodiment. The electrode assembly 100 of the present embodiment has the same structure as that of the second embodiment.

The method of producing of the electrode assembly 100 in the present embodiment is partially different from that in the second embodiment. The method of producing of the electrode assembly 100 according to the present embodiment is a method of producing the electrode assembly 100 in which the positive electrode 110 and the negative electrode 120 are disposed side by side with the separator 130 interposed therebetween, and includes a step of preparing the separator 130 (preparation step), a step of disposing the positive electrode 110 on the separator 130 (positive electrode disposing step), and a step of forming a folded-back portion 131 for positioning the positive electrode 110 with respect to the separator 130 by folding back the separator 130, and disposing the separator 130 on the positive electrode 110 (first folding step), a step of heating the first folded-back portion 131 to weld the separator 130 to the positive electrode 110 (first welding step), a step of disposing the negative electrode 120 on the separator 130 disposed on the positive electrode 110 (negative electrode disposing step), a step of forming a folded-back portion 132 for positioning the negative electrode 120 with respect to the separator 130 by folding back the separator 130, and disposing the separator 130 on the negative electrode 120 (a second folding step), and a step of heating the second folded-back portion 132 and welding the second folded-back portion 132 to the negative electrode 120 (a second welding step).

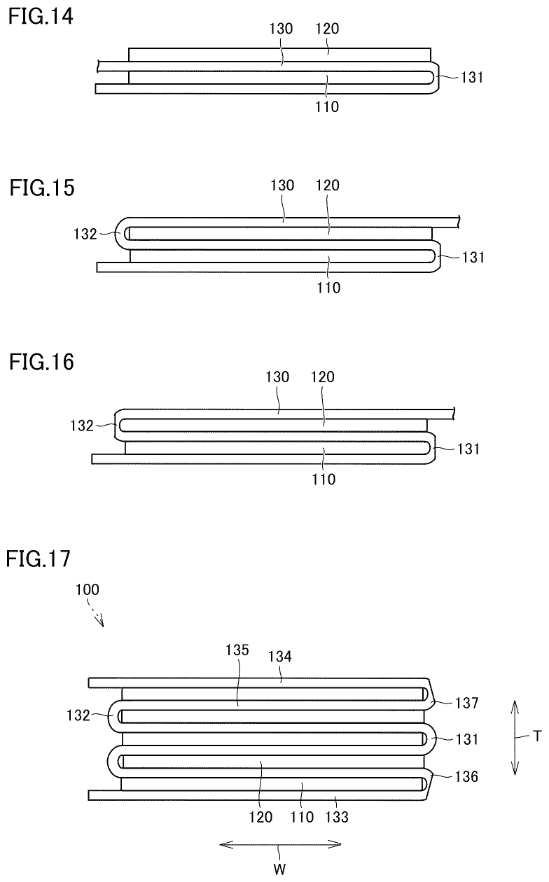

The method of producing the electrode assembly 100 according to the present embodiment is different from the second embodiment in that it includes a first welding step and a second welding step. Hereinafter, the first welding step and the second welding step will be described. FIG. 11 shows a state after the positive electrode disposing step, FIG. 12 shows a state after the first folding step, FIG. 14 shows a state after the negative electrode disposing step, and FIG. 15 shows a state after the second folding step.

In the first welding step, the first folded-back portion 131 is heated to be welded to the positive electrode 110. FIG. 13 shows a state after the first welding step.

In the second welding step, the second folded-back portion 132 is heated to be welded to the negative electrode 120. FIG. 16 shows the state after the second welding step.

In the present embodiment, the positive electrode disposing step, the first folding step, the first welding step, the negative electrode disposing step, the second folding step, and the second welding step are repeated in this order.

In the present embodiment, the third welding step of heating at least one selected from the group consisting of the upper portion 11 and the bottom portion 12 to weld the separator 130 to the positive electrode 110 and the negative electrode 120 may be included. In the third welding step, the upper portion 11 and the bottom portion 12 are preferably heated to be welded to the positive electrode 110 and the negative electrode 120.

The upper portion 11 and the bottom portion 12 may be heated simultaneously with the heating of the first folded-back portion 131 and the second folded-back portion 132 in the first welding step and the second welding step to weld the separator 130 to the positive electrode 110 and the negative electrode 120. That is, in the case shown in FIGS. 13 and 16, the separator 130 may be welded to the positive electrode 110 and the negative electrode 120 by heating the first folded-back portion 131 and the second folded-back portion 132 at the same time as heating the upper portion and the bottom portion sequentially in the electrode assembly forming process.

As described above, in the electrode assembly 100 and the method of producing the same according to the present embodiment, the positive electrode 110 and the negative electrode 120 are positioned with respect to the separator 130 by heating and welding the first folded-back portion 131 and the second folded-back portion 132 of the separator 130, so that positional displacement of the positive electrode 110 and the negative electrode 120 with respect to the separator 130 is suppressed.

### Embodiment 4

In this embodiment, an electrode assembly and a method of producing the electrode assembly which can be used in Embodiment 1 will be described with reference to the drawings. The description of the same contents as those of the first to third embodiments will be omitted.

FIG. 17 is a diagram schematically showing an electrode assembly according to the present embodiment. The electrode assembly 100 according to the present embodiment includes a plurality of positive electrodes 110 and a plurality of negative electrodes 120 arranged side by side in the thickness direction, a separator 130 formed in a folded shape to insulate the positive electrodes 110 and the negative electrodes 120 from each other, and has a shape elongated in the width direction orthogonal to both the thickness direction and the vertical direction than the thickness direction, and includes an upper portion 11, a bottom portion 12, a first end portion 13 positioned at one end in the width direction, and a second end portion 14 positioned at the other end in the width direction, the plurality of positive electrode 110 includes a positive electrode tab 112p protruding from the first end portion 13, and the plurality of negative electrode 120 includes a negative electrode tab 122n protruding from the second end portion 14. The separator 130 includes a first external separator 133, a second external separator 134, an internal separator 135, a first external folded-back portion 136, and a second external folded-back portion 137. The first external folded-back portion 136 connects the first external separator 133 and the internal separator 135. The second external folded-back portion 137 connects the second external separator 134 and the internal separator 135. The internal separator 135 includes a first folded-back portion 131 and a second folded-back portion 132. The first folded-back portion 131, the first external folded-back portion 136, and the second external folded-back portion 137 are formed in the first end portion 13. The second folded-back portion 132 is formed in the second end portion 14. The first external folded-back portion 136 and the second external folded-back portion 137 have chamfered shapes.

As shown in FIG. 17, the separator 130 of the electrode assembly 100 according to the present embodiment includes a first external separator 133 and a second external separator 134 arranged on the outermost side in the thickness direction of the electrode assembly 100, an internal separator 135 arranged inside, a first external folded-back portion 136 connecting the first external separator 133 and the internal separator 135, and a second external folded-back portion 137 connecting the second external separator 134 and the internal separator 135. The first external folded-back portion 136 and the second external folded-back portion 137 have chamfered shapes. In the electrode assembly 100 having such a shape, by inserting the electrode assembly 100 into the cell case from the first end portion 13 having a chamfered shape, the electrode assembly 100 can be smoothly inserted into the cell case. The separator 130 includes a first external separator 133, a first external folded-back portion 136, an internal separator 135, a second external folded-back portion 137, and a second external separator 134.

The chamfered shape is not particularly limited and may be an angled plane (rounded plane) shape instead of a sharp corner portion.

The method of producing the electrode assembly 100 according to the present embodiment is a method of producing the electrode assembly 100 in which the positive electrode 110 and the negative electrode 120 are arranged so as to be arranged with the separator 130 interposed therebetween, in which a step of preparing the separator 130 (preparation step), a step of disposing the positive electrode 110 on the separator 130 (first positive electrode disposing step), and a first external folded-back portion 136 for positioning the positive electrode 110 with respect to the separator 130 by folding the separator 130 are formed, a step of disposing the separator 130 on the positive electrode 110 (first external folding step), a step of disposing the negative electrode 120 on the separator 130 disposed on the positive electrode 110 (negative electrode disposing step), and a step of forming the folded-back portion 132 for positioning the negative electrode 120 with respect to the separator 130 by folding the separator 130, and a step of disposing the separator 130 on the negative electrode 120 (second folding step), a step of disposing the positive electrode 110 on the separator 130 disposed on the negative electrode 120 (a second positive electrode disposing step), a step of forming the second external folded-back portion 137 for positioning the positive electrode 110 with respect to the separator 130 by folding the separator 130, and a step of disposing the separator 130 on the positive electrode 110 (a second external folded step), and a step of heating the first external folded-back portion 136 and the second external folded-back portion 137 to form a chamfered shape (a chamfering step), includes:

The method of producing the electrode assembly 100 according to the present embodiment includes a chamfering step. Hereinafter, the chamfering step will be described.

In the chamfering step, the first external folded-back portion 136 and the second external folded-back portion 137 are heated to form a chamfered shape. The chamfered shape is formed by heating, i.e., the separator is cured by heating. Thus, even when the cell case and the chamfered portion of the electrode assembly 100 come into contact with each other when the electrode assembly 100 is inserted into the cell case, damage to portions other than the chamfered portion of the electrode assembly 100 is suppressed.

As described above, in the electrode assembly 100 and the method of producing the same according to the present embodiment, the first external folded-back portion 136 and the second external folded-back portion 137 are provided at the first end portions 13 of the first external separator 133 and the second external separator 134 arranged outermost in the thickness direction of the electrode assembly 100, and the first external folded-back portion 136 and the second external folded-back portion 137 form a chamfered shape. In the electrode assembly 100 having such a shape, by inserting the electrode assembly 100 into the cell case from the first end portion 13 having a chamfered shape, it is possible to smoothly insert the electrode assembly 100 into the cell case. Further, since the chamfered shape is formed by heating, even when the cell case and the chamfered shape portion of the electrode assembly 100 come into contact with each other when the electrode assembly 100 is inserted into the cell case, damage to portions other than the chamfered shape portion of the electrode assembly 100 is suppressed.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A power storage cell comprising:
an electrode assembly;
a cell case that accommodates the electrode assembly; and
an electrolyte solution accommodated in the cell case, wherein
the electrode assembly includes a plurality of positive electrodes and a plurality of negative electrodes disposed side by side in a thickness direction, and a separator that insulates each positive electrode and each negative electrode,
the electrode assembly has a shape longer in a width direction than in the thickness direction, the width direction being orthogonal to both the thickness direction and an upward/downward direction,
the electrode assembly includes an upper portion, a bottom portion, a first end portion located at one end in the width direction, and a second end portion located at the other end in the width direction,
each of the plurality of positive electrodes includes a positive electrode tab protruding from the first end portion,
each of the plurality of negative electrodes includes a negative electrode tab protruding from the second end portion,
a first welding portion is formed in the first end portion at a portion located below the positive electrode tab,
a second welding portion is formed in the second end portion at a portion located below the negative electrode tab,
a third welding portion in contact with the first welding portion and a fourth welding portion in contact with the second welding portion are formed in the bottom portion, and
the third welding portion and the fourth welding portion are disposed at an interval with a central portion of the bottom portion being interposed between the third welding portion and the fourth welding portion.

2. The power storage cell according to claim 1, wherein each of a height of the first welding portion and a height of the second welding portion is equal to or more than ⅓ and equal to or less than ½ of a height of the electrode assembly.

3. The power storage cell according to claim 1, wherein each of a length of the third welding portion in the width direction and a length of the fourth welding portion in the width direction is equal to or more than ¼ and equal to or less than ⅓ of a length of the electrode assembly in the width direction.

4. A method of producing an electrode assembly in which a positive electrode and a negative electrode are disposed side by side with a separator being interposed between the positive electrode and the negative electrode, the method comprising:
preparing the separator;
disposing the positive electrode on the separator;
forming a folded-back portion for positioning the positive electrode with respect to the separator by folding back the separator, and disposing the separator on the positive electrode;
welding the separator to the positive electrode by heating the separator;
disposing the negative electrode on the separator welded on the positive electrode;
forming a folded-back portion for positioning the negative electrode with respect to the separator by folding back the separator, and disposing the separator on the negative electrode; and
welding the separator to the negative electrode by heating the separator.
